(19) United States
(12) Patent Application Publication
(10) Pub. No.: US 2022/0109607 A1
(43) Pub. Date: Apr. 7, 2022

(54) CUSTOMER PREMISES EQUIPMENT CONFIGURATION MANAGEMENT METHOD AND APPARATUS

(71) Applicant: HUAWEI TECHNOLOGIES CO., LTD., Shenzhen (CN)

(72) Inventors: Tiejun WU, Wuhan (CN); Haixing LIU, Wuhan (CN); Guangrui LUO, Dongguan (CN)

(21) Appl. No.: 17/554,691

(22) Filed: Dec. 17, 2021

Related U.S. Application Data
(63) Continuation of application No. PCT/CN2020/083559, filed on Apr. 7, 2020.

(30) Foreign Application Priority Data
Jun. 21, 2019 (CN) 201910541405.9

(51) Int. Cl. H04L 41/0806; H04L 41/08; H04L 41/084; H04L 41/28; H04L 41/12; H04L 69/329

(52) U.S. Cl. CPC H04L 41/0806; H04L 41/0886; H04L 69/329; H04L 41/28; H04L 41/12; H04L 41/0846

(57) ABSTRACT

This application provides a CPE configuration management method. A CPE stores information about a first ACS and information about a second ACS. The information about the first ACS and the information about the second ACS are, for example, an identifier of the first ACS and an identifier of the second ACS. The information about the first ACS and the information about the second ACS may be manually configured, or may be configured by another ACS. Because the CPE is preset with the information about the first ACS and the information about the second ACS, the CPE can establish sessions with the first ACS and the second ACS, and simultaneously process first configuration information sent by the first ACS and second configuration information sent by the second ACS.

### CROSS-REFERENCE TO RELATED APPLICATIONS

This application is a continuation of International Application No. PCT/CN2020/083559, filed on Apr. 7, 2020, which claims priority to Chinese Patent Application No. 201910541405.9, filed on Jun. 21, 2019. The disclosures of the aforementioned applications are hereby incorporated by reference in their entireties.

### TECHNICAL FIELD

This application relates to the field of optical network communication, and more specifically, to a customer premises equipment configuration management method and apparatus.

### BACKGROUND

In a conventional solution, Broadband Forum defines, in a TR069 protocol, a framework for auto-configuration and remote management of optical terminals based on a customer premises equipment (CPE) wide area network management protocol (CWMP). It is further defined in the protocol that a data model for interaction between a CPE and an auto-configuration server (ACS) is in a one-to-one correspondence, that is, each CPE may be uniquely configured with an address of one ACS and communicate with the ACS. For example, configuration management of one CPE can be performed by only one ACS at a time point, and one CPE can interact with only one ACS at a time point.

However, with the continuous expansion of home network services, the current mode in which one CPE can be managed by only one ACS cannot meet actual service requirements. In other words, in the conventional solution, data processing efficiency is relatively low.

### SUMMARY

This application provides a method and an apparatus for processing data in parallel, to improve data processing efficiency.

In some embodiments (sometimes referred to as, “a first aspect”), a CPE configuration management method is provided, including: A CPE establishes a session connection to a first ACS, and/or receives (e.g., acquires, obtains, retrieves) first configuration information sent by the first ACS, where the first configuration information is a parameter configured by the first ACS based on a first data model. The CPE establishes (e.g., creates) a session connection to a second ACS, and/or receives second configuration information sent by the second ACS, where the second configuration information is a parameter configured by the second ACS based on a second data model. The CPE performs (e.g., executes, implements) configuration management operations of the first configuration information and/or the second configuration information.

The CPE stores information about the first ACS and information about the second ACS. The information about the first ACS and the information about the second ACS are, for example, an identifier of the first ACS and an identifier of the second ACS. The information about the first ACS and the information about the second ACS may be manually configured, or may be configured by another ACS. Because the CPE is preset with the information about the first ACS and the information about the second ACS, the CPE can establish sessions with the first ACS and the second ACS, and/or simultaneously process the first configuration information and/or the second configuration information. Compared with a conventional solution in which only configuration information of one ACS can be processed at a time, a CPE to which the foregoing technical solution is applied can split a complex service into a plurality of sub-services, report the sub-services to one (in this case, the first ACS and the second ACS may be considered as two functional models on one ACS) or more ACSs, and/or process the plurality of sub-services in parallel, thereby improving processing efficiency.

In some embodiments, the first configuration information includes role information of the first ACS, the second configuration information includes role information of the second ACS, the role information is used to indicate whether the ACS is a master ACS or a slave ACS, and/or the method further includes: The CPE receives the first configuration information from the first ACS. The CPE receives the second configuration information from the second ACS. The CPE preferably processes the first configuration information based on the role information.

Each piece of configuration information includes a master/slave status of an ACS that sends the configuration information. In this way, the CPE can be prevented from determining the master/slave status of the ACS, thereby reducing a communication latency or signaling overheads.

In some embodiments, the first ACS is a master ACS, the second ACS is a slave ACS, and before the CPE establishes the session connection to the second ACS, and/or receives the second configuration information sent by the second ACS, the method further includes: The CPE activates the second ACS based on the first configuration information.

The slave ACS may be activated (e.g., enabled, started, triggered) by the master ACS when necessary, and deactivated by the master ACS when unnecessary. In this way, the CPE can have abundant resources to process the configuration information of the master ACS.

In some embodiments, the first ACS is a master ACS, the second ACS is a slave ACS, the first configuration information is security configuration information, and the second configuration information is service configuration information.

The CPE can split services to different ACSs for separate configuration management without affecting each other. For example, an operator may split, based on service types and/or different security levels, different services to different sub-departments or ACSs of sub-operators for configuration management, to meet diversified and complex service configuration management requirements of a current home network.

In some embodiments, the first data model is a data model based on a non-TR069 protocol, and the second data model is a data model based on a TR069 protocol.

In some embodiments, the master ACS may configure information about the second ACS on the CPE by using a data model of a non-TR069 protocol, so that the CPE can simultaneously interact with a plurality of ACSs. In the foregoing solution, the TR069 protocol does not need to be modified, thereby simplifying a method for interacting with a plurality of ACSs by the CPE.

In some embodiments (sometimes referred to as, “a second aspect”), another CPE configuration management method is provided, including: a first ACS establishes a session connection to a CPE, and/or sends (e.g., provides, transmits, delivers) first configuration information, where the first configuration information is used to configure the CPE to be capable of simultaneously performing configuration management operations of the first ACS and a second ACS, the first ACS is a master ACS, and the second ACS is a slave ACS. The first ACS communicates with the CPE.

The CPE is preset with information about the master ACS, and the master ACS sends information about the second ACS to the CPE, so that the CPE stores the information about the first ACS and the information about the second ACS. In this way, the CPE can establish sessions with the first ACS and the second ACS, and simultaneously process the first configuration information and second configuration information. Compared with a conventional solution in which only configuration information of one ACS can be processed at a time, a CPE to which the foregoing technical solution is applied can split a complex service into a plurality of sub-services, report the sub-services to one (in this case, the first ACS and the second ACS may be considered as two functional models on one ACS) or more ACSs, and process the plurality of sub-services in parallel, thereby improving processing efficiency. The information about the first ACS and the information about the second ACS are, for example, an identifier of the first ACS and an identifier of the second ACS.

In some embodiments, the first configuration information is security configuration information.

The CPE can split services to different ACSs for separate configuration management without affecting each other. For example, an operator may split, based on service types and different security levels, different services to different sub-departments or ACSs of sub-operators for configuration management, and the master ACS is responsible for a service with a relatively high security requirement, that is, the first configuration information is security configuration information, thereby meeting diversified and complex service configuration management requirements of a current home network.

In some embodiments, the first data model is a data model based on a non-TR069 protocol.

In some embodiments, the master ACS may configure information about the second ACS on the CPE by using a data model of a non-TR069 protocol, so that the CPE can simultaneously interact with a plurality of ACSs. In the foregoing solution, the TR069 protocol does not need to be modified, thereby simplifying a method for interacting with a plurality of ACSs by the CPE.

In some embodiments (sometimes referred to as, “a third aspect”), a CPE configuration management apparatus is provided. The apparatus has functions of implementing the first aspect and the possible implementations.

In some embodiments (sometimes referred to as, “a fourth aspect”), a CPE configuration management apparatus is provided. The apparatus has functions of implementing the second aspect and the possible implementations.

In some embodiments (sometimes referred to as, “a fifth aspect”), a CPE configuration management apparatus is provided. The apparatus may be a CPE, or may be a chip in the CPE. The apparatus has a function of implementing the first aspect and various possible implementations of the first aspect. The function may be implemented by hardware, or may be implemented by hardware executing corresponding software. The hardware or the software includes one or more units corresponding to the function.

In some embodiments, the apparatus includes a transceiver unit and a processing unit. The transceiver unit may be, for example, at least one of a transceiver, a receiver, or a transmitter. The transceiver unit may include a radio frequency circuit or an antenna. The processing unit may be a processor.

In some embodiments, the apparatus further includes a storage unit, and the storage unit may be, for example, a memory. When a storage unit is included, the storage unit is configured to store instructions. The processing unit is connected to the storage unit, and the processing unit may execute the instructions stored in the storage unit or instructions from another unit, to enable the apparatus to perform the method in any one of the first aspect or the possible implementations of the first aspect. In some embodiments, the device may be a CPE.

In some embodiments, when the apparatus is a chip, the chip includes a transceiver unit and a processing unit. The transceiver unit may be, for example, an input/output interface, a pin, or a circuit on the chip. The processing unit may be, for example, a processor. The processing unit may execute instructions, to enable the apparatus to perform the method in any one of the first aspect or the possible implementations of the first aspect.

In some embodiments, the processing unit may execute instructions in a storage unit, and the storage unit may be a storage unit, for example, a register or a cache, in the chip. The storage unit may alternatively be located inside a communication device but outside the chip, for example, a read-only memory (ROM) or another type of static storage device that can store static information and instructions, or a random access memory (RAM).

The processor mentioned above may be a general-purpose central processing unit (CPU), a microprocessor, an application-specific integrated circuit (ASIC), or one or more integrated circuits configured to control program execution of the communication method according to the foregoing aspects.

In some embodiments (sometimes referred to as, “a sixth aspect”), a CPE configuration management apparatus is provided. The apparatus may be an ACS, or may be a chip in the ACS. The apparatus has a function of implementing the second aspect and various possible implementations of the second aspect. The function may be implemented by hardware, or may be implemented by hardware executing corresponding software. The hardware or the software includes one or more units corresponding to the function.

In some embodiments, the apparatus includes a transceiver unit and a processing unit. The transceiver unit may be, for example, at least one of a transceiver, a receiver, or a transmitter. The transceiver unit may include a radio frequency circuit or an antenna. The processing unit may be a processor.

In some embodiments, the apparatus further includes a storage unit, and the storage unit may be, for example, a memory. When a storage unit is included, the storage unit is configured to store instructions. The processing unit is connected to the storage unit, and the processing unit may execute the instructions stored in the storage unit or instructions from another unit, to enable the apparatus to perform the method in any one of the second aspect or the possible implementations of the second aspect.

In some embodiments, when the apparatus is a chip, the chip includes a transceiver unit and a processing unit. The transceiver unit may be, for example, an input/output interface, a pin, or a circuit on the chip. The processing unit may be, for example, a processor. The processing unit may execute instructions, to enable the apparatus to perform the method in any one of the second aspect or the possible implementations of the second aspect.

In some embodiments, the processing unit may execute instructions in a storage unit, and the storage unit may be a storage unit, for example, a register or a cache, in the chip. The storage unit may alternatively be located inside a communication device but outside the chip, for example, a read-only memory (ROM) or another type of static storage device that can store static information and instructions, or a random access memory (RAM).

The processor mentioned above may be a general-purpose central processing unit (CPU), a microprocessor, an application-specific integrated circuit (ASIC), or one or more integrated circuits configured to control program execution of the communication method according to the foregoing aspects.

In some embodiments (sometimes referred to as, “a seventh aspect”), a computer storage medium is provided. The computer storage medium stores program code, and the program code is used to indicate instructions for performing the method according to any one of the first aspect and the possible implementations of the first aspect.

In some embodiments (sometimes referred to as, “an eighth aspect”), a computer storage medium is provided. The computer storage medium stores program code, and the program code is used to indicate instructions for performing the method according to any one of the second aspect and the possible implementations of the second aspect.

In some embodiments (sometimes referred to as, “a ninth aspect”), a computer program product including instructions is provided. When the computer program product runs on a computer, the computer is enabled to perform the method according to any one of the first aspect or the possible implementations of the first aspect.

In some embodiments (sometimes referred to as, “a tenth aspect”), a computer program product including instructions is provided. When the computer program product runs on a computer, the computer is enabled to perform the method according to any one of the second aspect or the possible implementations of the second aspect.

In some embodiments (sometimes referred to as, “an eleventh aspect”), a communication system is provided. The communication system includes the apparatus according to the fifth aspect and the apparatus according to the sixth aspect.

### BRIEF DESCRIPTION OF DRAWINGS

FIG. 1 is a schematic block diagram of a communication system according to an embodiment of this application;

FIG. 2 is a schematic flowchart of interaction between a CPE and an ACS in a conventional solution;

FIG. 3 is a schematic flowchart of a CPE configuration management method according to this application;

FIG. 4 is a schematic diagram of another CPE configuration management method according to this application;

FIG. 5 is a schematic block diagram of a CPE configuration management apparatus according to this application;

FIG. 6 is a schematic diagram of a structure of another CPE configuration management apparatus according to this application;

FIG. 7 is a schematic block diagram of still another CPE configuration management apparatus according to this application; and

FIG. 8 is a schematic block diagram of still another CPE configuration management apparatus according to this application.

### DESCRIPTION OF EMBODIMENTS

For ease of understanding, related terms in this application are first briefly described.

TR069:

TR069 is a protocol proposed by digital subscriber line (DSL) Forum, which is a CWMP protocol, and is mainly used to manage user terminals. TR069 defines a network management system structure, including a “management model”, an “interaction interface”, and a “management parameter”, which greatly reduces operation and maintenance costs of network products.

CWMP Protocol:

A simple object access protocol that is easy to extend, maintain, and understand is used to encapsulate exchanged messages, to implement extensible markup language encapsulation and parsing. A data model supported by a CPE is used to manage service functions supported by the CPE, to implement secure and reliable management of CPE services.

Remote Process Call (RPC):

RPC is an encapsulation method in a TR069 protocol specification. An RPC instruction may include at least one of: a method used by an ACS to discover capacities of the CPE, a method for obtaining a device parameter name, a method for setting a device parameter, a method for adding an object, a method for deleting an object, a method for uploading a log or configuration of a device, a method for downloading a device version or configuration, a method for restarting a device, a method used by a device to report an uploading or downloading result to a server, a method for restoring a factory reset of a device, or a method used by a device to actively upload a file to a server.

Data Model

The RPC method is used to manage data models.

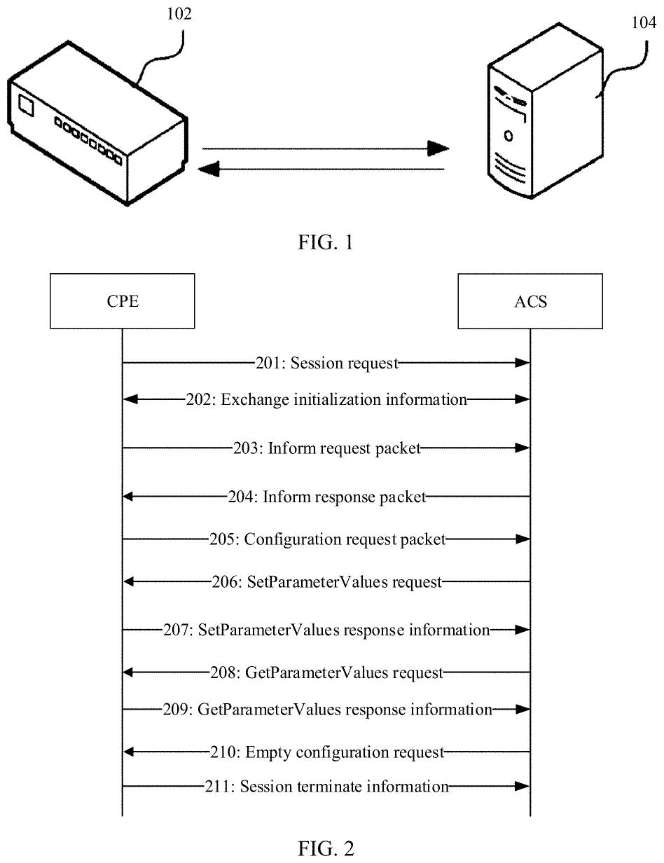

FIG. 1 is a schematic block diagram of a communication system according to an embodiment of this application. As shown in FIG. 1, the communication system includes a CPE 102 and an ACS 104. The ACS 104 may be responsible for managing the CPE 102. An interface between the ACS 104 and the CPE 102 is a southbound interface, and interaction between the CPE 102 and the ACS 104 is based on a uniform resource locator (URL). The URL is a concise representation of a location and an access method of a resource that can be obtained from the Internet, and is an address of a standard Internet resource.

The ACS may generally refer to all management servers. The management server may be implemented by using an independent server or a server cluster including a plurality of servers, and the ACS corresponds to a HeMS. The HeMS may refer to a network management system configured to monitor a small cell.

The CPE may generally refer to a terminal. The terminal in embodiments of this application may be user equipment, an access terminal, a subscriber unit, a subscriber station, a mobile station, a remote station, a remote terminal, a mobile device, a user terminal, a wireless communication device, a user agent, or a user apparatus. The terminal may alternatively be a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, a vehicle-mounted device, a wearable device, a terminal in a 5G network, a terminal in a future evolved public land mobile network (PLMN), or the like. This is not limited in the embodiments of this application.

In the embodiments of this application, the terminal includes a hardware layer, an operating system layer running above the hardware layer, and an application layer running above the operating system layer. The hardware layer includes hardware such as a central processing unit (CPU), a memory management unit (MMU), and a memory (which is also referred to as a main memory). An operating system may be any one or more computer operating systems that implement service processing through a process, for example, a Linux operating system, a Unix operating system, an Android operating system, an iOS operating system, or a Windows operating system. The application layer includes applications such as a browser, an address book, word processing software, and instant messaging software. In addition, a specific structure of an entity for performing a method provided in the embodiments of this application is not particularly limited in the embodiments of this application, provided that the entity can run a program that records code of the method provided in the embodiments of this application to perform communication according to the method provided in the embodiments of this application. For example, the entity for performing the method provided in the embodiments of this application may be an ACS, a CPE, or a functional module that is in an ACS or a CPE and that can invoke and execute the program.

The technical solutions in the embodiments of this application may be applied to various communication systems in which the TR069 protocol is used for interaction.

FIG. 2 is a schematic flowchart of interaction between a CPE and an ACS in a conventional solution.

201: The CPE sends a session request (e.g., open connection) to the ACS.

202: The CPE exchanges initialization information, for example, encryption/decryption information, with the ACS.

203: The CPE sends an information request packet to the ACS.

204: The ACS sends an information response packet to the CPE.

205: The CPE sends a configuration request (HTTP POST) packet with an empty payload to the ACS, to allow the ACS to manage the CPE.

206: The ACS sends a SetParameterValues request to the CPE, to configure one or more parameter values (e.g., structured parameters or unstructured parameters) of a node corresponding to the CPE.

207: The CPE sends SetParameterValues response information to the ACS.

208: The ACS sends a GetParameterValues request to the CPE, to obtain one or more parameter values of the node corresponding to the CPE.

209: The CPE sends GetParameterValues response information to the ACS.

210: After the ACS sends an HTTP RESPONSE packet with an empty payload to the CPE, a management session process ends.

211: The CPE sends session terminate information to the ACS.

In the conventional solution, the mode in which one CPE can be managed by only one ACS cannot meet actual service requirements. In other words, in the conventional solution, data processing efficiency is relatively low.

FIG. 3 is a schematic flowchart of a CPE configuration management method according to this application.

301: A CPE sends a first session request to a first ACS. Correspondingly, the first ACS receives the first session request.

302: The CPE sends a second session request to a second ACS. Correspondingly, the second ACS receives the second session request.

It should be noted that the embodiments of this application may be further applied to a communication system including more ACSs. This is not limited in this application.

303: The CPE receives first configuration information sent by the first ACS and second configuration information sent by the second ACS, where the first configuration information is a parameter configured by the first ACS based on a first data model, and the second configuration information is a parameter configured by the second ACS based on a second data model.

For example, the first ACS sends the first configuration information, where the first configuration information is used to configure the CPE to be a CPE capable of processing data of the first ACS; and the second ACS sends the second configuration information, where the second configuration information is used to configure the CPE to be a CPE capable of processing data of the second ACS. In this embodiment of this application, the CPE configures, based on the first configuration information and the second configuration information, the CPE to be a CPE capable of simultaneously processing the data of the first ACS and the second ACS.

The CPE may perform configuration with reference to the configuration information of the first ACS and the second ACS, that is, perform configuration concurrently. In some embodiments, the CPE may separately perform configuration for the first ACS and the second ACS.

In some embodiments, the configuration information is further used to indicate whether a corresponding ACS is a master ACS or a slave ACS.

Each piece of configuration information may include a master/slave status of an ACS that sends the configuration information. For example, the first configuration information indicates whether the first ACS is a master ACS or a slave ACS. The second configuration information indicates whether the second ACS is a master ACS or a slave ACS. The first ACS and the second ACS may agree in advance on which ACS is used as a master ACS, and other ACSs are all slave ACSs. For example, priorities of the ACSs may be set based on a factory reset, and an ACS with a highest priority is a master ACS. In this way, when sending the configuration information to the CPE, the ACS may further indicate whether the ACS is a master ACS or a slave ACS.

It should be understood that, in this embodiment of this application, the slave ACS may also be referred to as a “sub-ACS”.

In some embodiments, the configuration information may indicate, by using a character string, that the corresponding ACS is a master ACS or a slave ACS.

It should be noted that, the master ACS may be referred to as a “common management server”, that is, the common management server may be consistent with definition in the TR069 protocol, and the master ACS may manage all content of the CPE. The slave ACS may be referred to as a backup server. By default, only a lboot event is reported. A status of the slave server is determined. If the master server is normal, the CPE does not accept other operations of the slave server.

In some embodiments, if the master ACS is online and the slave ACS is offline, the first configuration information is used to configure the CPE to be capable of simultaneously processing the data of the first ACS and the second ACS, that is, the CPE may activate the slave ACS based on the first configuration information.

For example, the slave ACS may send, to the master ACS, related information for configuring the CPE to be capable of processing the data of the slave ACS, and the master ACS sends configuration information to the CPE, so that the CPE can be configured to be a device that simultaneously processes data of the plurality of ACSs.

In some embodiments, the configuration information sent by the ACS includes a data model, and the data model includes any one of a full data model, a none data model, or a non-data model.

For example, configuration information may include a data model, but different configuration information may include different data models. For example, the data model may be a full data model or a none data model. The full data model may mean that after receiving the configuration information, the CPE reports all supported data models to the ACS. The none data model means supporting only some operational RPC, such as reset and inform, but does not report any data model.

It should be noted that, in this application, a protocol may be extended, and the data model may be extended in the protocol. In addition, to ensure security, when the master ACS learns by query that the CPE has a data model, node information of the slave ACS may be obtained by query. However, an extended slave ACS cannot view node information of the master ACS. For example, the slave ACS can view only configuration information of a local node.

In some embodiments, the data model in the configuration information sent by the master ACS is a data model based on the TR069 protocol, and the data model in the configuration information sent by the slave ACS is a data model based on a non-TR069 protocol.

In some embodiments, the configuration information further includes an RPC method.

For example, the RPC method includes a full RPC method or a none RPC method. The full RPC method indicates that all RPC methods supported by the CPE are supported for the ACS. The none RPC method indicates that the CPE does not support any RPC method for the ACS.

In some embodiments, the CPE receives different configuration information from the first ACS and the second ACS.

For example, some or all of the plurality of ACSs may have different data to be processed. In this case, different ACSs send different configuration information to the CPE. In other words, the CPE can process more different types of data in parallel, thereby further improving data processing efficiency. For example, the first ACS may configure administrator information and some sensitive data information of the CPE, that is, the first configuration information is security configuration information. The second ACS configures and manages only other non-sensitive data of the CPE, that is, the second configuration information is service configuration information.

It should be noted that the first ACS and the second ACS may be isolated or shared on a network. This is not limited in this application.

It should be understood that the first ACS and the second ACS may be physically isolated on a network. For example, a container or a device is used to isolate interaction between different ACSs.

In some embodiments, the CPE may determine (e.g., ascertain, assess), based on a network state, whether to switch the master ACS.

For example, the CPE may determine, based on a network state such as communication efficiency between the CPE and the current master ACS, whether the master ACS needs to be replaced. If the network state between the CPE and the current master ACS is less than a preset threshold, the CPE determines to switch the master ACS. If the network state between the CPE and the current master ACS is greater than the preset threshold, the CPE determines that the master ACS does not need to be switched. In this way, communication performance can be improved in this embodiment of this application.

304: The CPE performs configuration management operations of the first configuration information and the second configuration information.

For example, after receiving the first configuration information and the second configuration information, the CPE can simultaneously process data received from the first ACS and the second ACS. Compared with a conventional solution in which only data received from one ACS can be separately processed, communication efficiency is improved in this embodiment of this application.

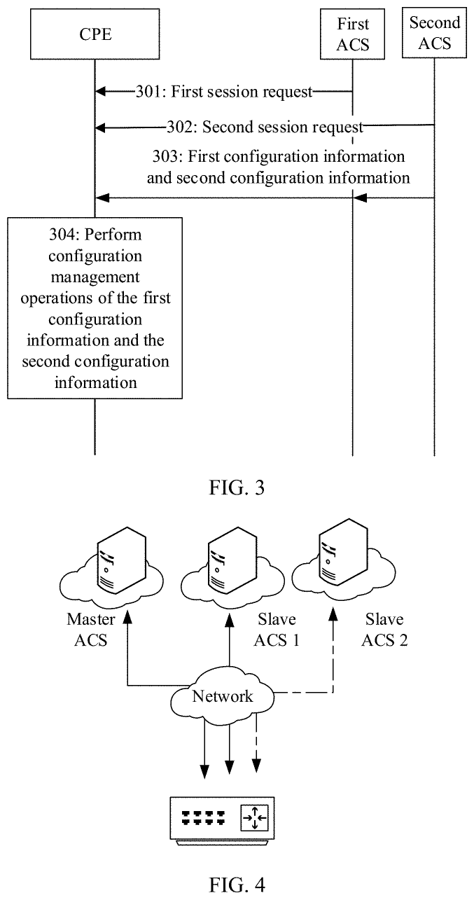

For example, as shown in FIG. 4, a CPE simultaneously processes data received from a master ACS, a slave ACS 1, and a slave ACS 2.

It should be noted that, that the CPE simultaneously processes data received from the ACSs may mean that the same CPE simultaneously sends inform messages to the plurality of ACSs, or the CPE may simultaneously receive query or management requests sent by the plurality of ACSs.

It should be further noted that, an operator may split, based on service types and different security levels, different services to different ACSs for management, thereby meeting diversified and complex service management of a current home network.

In some embodiments, operation 304 may be specifically as follows: The CPE sends session requests to the plurality of ACSs, and after completing session interaction with each ACS, sends session terminate information to the corresponding ACS. A sending moment of sending a session request to an M^{th} ACS in the plurality of ACSs is earlier than a sending moment of sending session terminate information to an N^{th} ACS, and both M and N are positive integers.

For example, a manner in which the CPE processes data received from an ACS may be a procedure shown in FIG. 2. If the CPE processes data received from a plurality of ACSs, the CPE may start data processing of one ACS before data processing of another ACS is completed. For example, before sending the session terminate information to the N^{th} ACS, the CPE may send the session request to the M^{th} ACS. In other words, a processing procedure in which the CPE processes data of the M^{th} ACS may be interleaved with a processing procedure in which the CPE processes data of the N^{th} ACS, for example, without a specific order. In this way, compared with a conventional solution in which the CPE can send a session request to one ACS only after sending session terminate information to another ACS, communication efficiency is improved in this embodiment of this application.

It should be noted that, the CPE may process, in a partially interleaved or entirely interleaved manner, the data received from the plurality of ACSs. This is not limited in this application.

It should be further noted that, in this embodiment of this application, a start procedure in which the CPE processes the data received from the ACS is sending a session request to the ACS by the CPE. If the start procedure in which the CPE processes the data received from the ACS is another operation, the “sending a session request” needs to be replaced with the “start procedure”. Correspondingly, if an end procedure in which the CPE processes the data received from the ACS is not sending session terminate information, the “sending session terminate information” needs to be replaced with the “end procedure”.

For example, in a scenario in which the CPE simultaneously communicates with the first ACS and the second ACS, a sending moment at which the CPE sends second session request information to the second ACS is earlier than a sending moment of sending first session terminate information. The first session terminate information is sent after the first ACS completes session interaction with the CPE.

In an embodiment, if an ACS may be divided into functional modules, the plurality of functional modules in the ACS may be considered as the plurality of ACSs, and different functional modules may be used to have different data processing requirements.

In some embodiments, if each of the plurality of ACSs may be divided into functional modules, system performance can be further improved in this embodiment of this application.

In another embodiment, one CPE is configured as an ACS of another CPE, that is, synchronization of only part of configuration information is supported. In this way, the ACS in this embodiment of this application may also be considered as a CPE, that is, configuration synchronization between CPEs is supported. For some common parameters, configuration performance can be improved more efficiently.

It should be noted that, in this scenario, a model for synchronizing parameters between CPEs needs to be defined, individual parameters need to be delivered by the ACS, and common parameters may be directly synchronized between the CPEs. In addition, the master ACS needs to dynamically deliver configuration parameters of the sub-ACS.

In still another embodiment, the embodiments of this application may be further applied to a home network. A gateway replaces the ACS and delivers configuration to another network device in the home network. That is, the gateway is considered as an ACS, and the another network device in the home network is considered as a CPE. In this way, related devices inside the home network can autonomously synchronize configuration data of the ACS. In addition, an ACS of an operator can manage devices inside the home network in parallel.

It should be noted that, in this scenario, a master ACS of the another device in the home network is filled with an ACS address of the operator, and an extended ACS is filled with an address of the gateway.

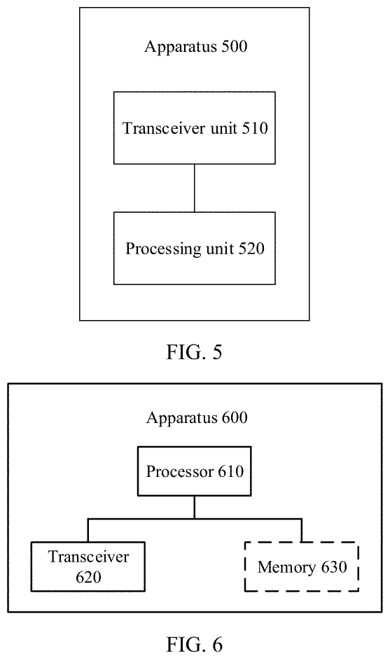

FIG. 5 is a schematic block diagram of a CPE apparatus 500 for configuration management according to this application.

It should be understood that the apparatus 500 may correspond to the CPE shown in FIG. 3, and may have any function of the CPE in the method. The apparatus 500 includes a transceiver unit 510 and a processing unit 520.

The transceiver unit 510 is configured to send a first session request to a first auto-configuration server (ACS).

The transceiver unit 510 is further configured to send a second session request to a second ACS.

The transceiver unit 510 is further configured to receive first configuration information and second configuration information that are delivered by the first ACS and the second ACS, where the first configuration information is a parameter configured by the first ACS based on a first data model, and the second configuration information is a parameter configured by the second ACS based on a second data model.

The processing unit 520 is configured to perform configuration management operations of the first configuration information and the second configuration information.

In some embodiments, the first configuration information includes role information of the first ACS, the second configuration information includes role information of the second ACS, and the role information is used to indicate whether the ACS is a master ACS or a slave ACS. The transceiver unit 510 is specifically configured to receive the first configuration information from the first ACS, and receive the second configuration information from the second ACS. The processing unit 520 is further configured to preferably process the first configuration information based on the role information.

In some embodiments, the first ACS is a master ACS, the second ACS is a slave ACS, and before the apparatus establishes the session connection to the second ACS, and receives the second configuration information sent by the second ACS, the processing unit 520 is further configured to activate the second ACS based on the first configuration information.

FIG. 6 is a schematic diagram of a structure of another CPE configuration management apparatus 600 according to this application. The apparatus 600 may be the CPE shown in FIG. 3. The apparatus may use a hardware architecture shown in FIG. 6. The apparatus may include a processor 610 and a transceiver 620. In some embodiments, the apparatus may further include a memory 630. The processor 610, the transceiver 620, and the memory 630 communicate with each other through an internal connection path. A related function implemented by the processing unit 520 in FIG. 5 may be implemented by the processor 610, and a related function implemented by the transceiver unit 510 may be implemented by the processor 610 by controlling the transceiver 620.

In some embodiments, the processor 610 may be a general-purpose central processing unit (CPU), a microprocessor, an application-specific integrated circuit (ASIC), a special-purpose processor, or one or more integrated circuits configured to perform the technical solutions in the embodiments of this application. In some embodiments, the processor may be one or more devices, circuits, and/or processing cores configured to process data (for example, computer program instructions). For example, the processor may be a baseband processor or a central processing unit. The baseband processor may be configured to process a communication protocol and communication data. The central processing unit may be configured to control a parallel data processing apparatus, execute a software program, and process data of the software program.

In some embodiments, the processor 610 may include one or more processors, for example, include one or more central processing units (CPU). When the processor is one CPU, the CPU may be a single-core CPU, or may be a multi-core CPU.

The transceiver 620 is configured to send and receive data and/or signals. The transceiver may include a transmitter and a receiver. The transmitter is configured to send the data and/or the signal, and the receiver is configured to receive the data and/or the signal.

The memory 630 includes but is not limited to a random access memory (RAM), a read-only memory (ROM), an erasable programmable read-only memory (EPROM), and a compact disc read-only memory (CD-ROM). The memory 630 is configured to store related instructions and data.

The memory 630 is configured to store program code and data, and may be a separate device or integrated into the processor 610.

For example, the processor 610 is configured to control the transceiver to perform information transmission with an ACS. For details, refer to the descriptions in the method embodiments. Details are not described herein again.

FIG. 7 is a schematic block diagram of still another CPE configuration management apparatus 700 according to this application.

It should be understood that the apparatus 700 may correspond to the ACS in FIG. 3, for example, the first ACS. The device may have any function of the ACS in the method. The apparatus 700 includes a transceiver unit 710 and a processing unit 720.

The transceiver unit 710 establishes a session connection to a CPE, and sends first configuration information, where the first configuration information is used to configure the CPE to be capable of simultaneously performing configuration management operations of the first ACS and a second ACS, an ACS corresponding to the apparatus 700 is a master ACS, and the second ACS is a slave ACS.

The processing unit 720 is configured to communicate with the CPE by using the transceiver unit 710.

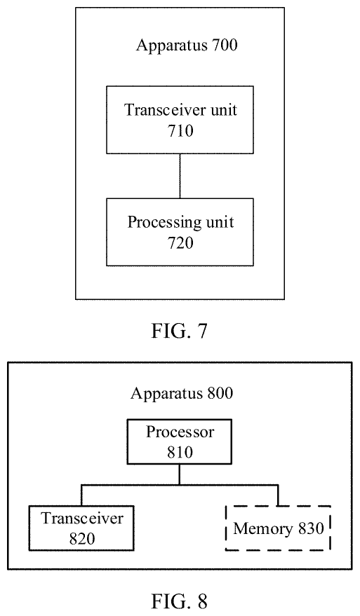

FIG. 8 is a schematic diagram of a structure of still another CPE configuration management apparatus 800 according to this application. The apparatus 800 may be the ACS in FIG. 3 and FIG. 4. The apparatus may use a hardware architecture shown in FIG. 8. The apparatus may include a processor 810 and a transceiver 820. In some embodiments, the apparatus may further include a memory 830. The processor 810, the transceiver 820, and the memory 830 communicate with each other through an internal connection path. A related function implemented by the processing unit 720 in FIG. 7 may be implemented by the processor 810, and a related function implemented by the transceiver unit 710 may be implemented by the processor 810 by controlling the transceiver 820.

In some embodiments, the processor 810 may be a general-purpose central processing unit (CPU), a microprocessor, an application-specific integrated circuit (ASIC), a special-purpose processor, or one or more integrated circuits configured to perform the technical solutions in the embodiments of this application. In some embodiments, the processor may be one or more devices, circuits, and/or processing cores configured to process data (for example, computer program instructions). For example, the processor may be a baseband processor or a central processing unit. The baseband processor may be configured to process a communication protocol and communication data. The central processing unit may be configured to control an information processing apparatus, execute a software program, and process data of the software program.

In some embodiments, the processor 810 may include one or more processors, for example, include one or more central processing units (CPU). When the processor is one CPU, the CPU may be a single-core CPU, or may be a multi-core CPU.

The transceiver 820 is configured to send and receive data and/or signals. The transceiver may include a transmitter and a receiver. The transmitter is configured to send the data and/or the signal, and the receiver is configured to receive the data and/or the signal.

The memory 830 includes but is not limited to a random access memory (RAM), a read-only memory (ROM), an erasable programmable read-only memory (EPROM), and a compact disc read-only memory (CD-ROM). The memory 830 is configured to store related instructions and data.

The memory 830 is configured to store program code and data, and may be a separate device or integrated into the processor 810.

For example, the processor 810 is configured to control the transceiver to perform information transmission with a CPE. For details, refer to the descriptions in the method embodiments. Details are not described herein again.

A person of ordinary skill in the art may be aware that, in combination with the examples described in the embodiments disclosed in this specification, units and algorithm operations can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that for the purpose of convenient and brief description, for a detailed working process of the described system, apparatus, and unit, refer to a corresponding process in the foregoing method embodiments. Details are not described herein again.

In the several embodiments provided in this application, it should be understood that the disclosed system, apparatus, and method may be implemented in other manners. For example, the apparatus embodiments described above are only examples. For example, division into the units is only logical function division, and may be other division during actual implementation. For example, a plurality of units or components may be combined or integrated into another system, or some features may be ignored or may not be performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this application may be integrated into one processing unit, or each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a computer software product. The computer software product is stored in a storage medium, and includes several instructions for instructing a computer device (which may be a personal computer, a server, or a network device) to perform all or some of the operations of the methods described in the embodiments of this application. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method, comprising:
establishing, by a customer premises equipment (CPE), a session connection to a first auto-configuration server (ACS), and receiving first configuration information sent by the first ACS;
establishing, by the CPE, a session connection to a second ACS, and receiving second configuration information sent by the second ACS; and
performing, by the CPE, configuration management operations of the first configuration information and the second configuration information.

2. The method of claim 1, wherein the first configuration information comprises role information of the first ACS, the second configuration information comprises role information of the second ACS, the role information is used to indicate whether the ACS is a master ACS or a slave ACS, and the method further comprises:
receiving, by the CPE, the first configuration information from the first ACS;
receiving, by the CPE, the second configuration information from the second ACS; and
preferably processing, by the CPE, the first configuration information based on the role information.

3. The method of claim 1, wherein the first ACS is a master ACS, the second ACS is a slave ACS, and before the establishing, by the CPE, a session connection to a second ACS, and receiving second configuration information sent by the second ACS, the method further comprises:
activating, by the CPE, the second ACS based on the first configuration information.

4. The method of claim 1, wherein the first ACS is a master ACS, the second ACS is a slave ACS, the first configuration information is security configuration information, and the second configuration information is service configuration information.

5. The method of claim 1, wherein the first configuration information is a parameter configured by the first ACS based on a first data model, and the second configuration information is a parameter configured by the second ACS based on a second data model.

6. The method of claim 5, wherein the first data model is a data model based on a non-TR069 protocol, and the second data model is a data model based on a TR069 protocol.

7. A method, comprising:
establishing, by a first auto-configuration server (ACS), a session connection to a customer premises equipment (CPE), and sending first configuration information, wherein the first configuration information is used to configure the CPE to be capable of simultaneously performing configuration management operations of the first ACS and a second ACS, the first ACS is a master ACS, and the second ACS is a slave ACS; and
communicating, by the first ACS, with the CPE.

8. The method of claim 7, wherein the first configuration information is security configuration information.

9. The method of claim 7, wherein the first configuration information is a parameter configured by the first ACS based on a first data model, and the second configuration information is a parameter configured by the second ACS based on a second data model.

10. The method of claim 9, wherein the first data model is a data model based on a non-TR069 protocol, and the second data model is a data model based on a TR069 protocol.

11. An apparatus, comprising
a processor, a receiver, and
a computer readable storage medium storing a plurality of processor-executable instructions that, when executed by the processor, cause the processor and the receiver to perform operations comprising:
establishing a session connection to a first auto-configuration server (ACS), and receive first configuration information sent by the first ACS;
establishing a session connection to a second ACS, and receive second configuration information sent by the second ACS; and
performing configuration management operations of the first configuration information and the second configuration information.

12. The apparatus of claim 11, wherein the first configuration information comprises role information of the first ACS, the second configuration information comprises role information of the second ACS, and the role information is used to indicate whether the ACS is a master ACS or a slave ACS, and
wherein the operations further comprising: receiving the first configuration information from the first ACS, and receiving the second configuration information from the second ACS; and
preferably processing the first configuration information based on the role information.

13. The apparatus of claim 11, wherein the first ACS is a master ACS, the second ACS is a slave ACS, and before the apparatus establishes the session connection to the second ACS, and receives the second configuration information sent by the second ACS, wherein the operations further comprising:
activating the second ACS based on the first configuration information.

14. The apparatus of claim 11, wherein the first ACS is a master ACS, the second ACS is a slave ACS, the first configuration information is security configuration information, and the second configuration information is service configuration information.

15. The apparatus of claim 11, wherein the first configuration information is a parameter configured by the first ACS based on a first data model, and the second configuration information is a parameter configured by the second ACS based on a second data model.

16. The apparatus of claim 15, wherein the first data model is a data model based on a non-TR069 protocol, and the second data model is a data model based on a TR069 protocol.

17. An apparatus, comprising
a processor, a transmitter, and
a computer readable storage medium having program instructions stored therein, which when executed by the processor, cause the processor to perform operations comprising:
establishing a session connection to a customer premises equipment (CPE), and send first configuration information by using the transmitter, wherein the first configuration information is used to configure the CPE to be capable of simultaneously performing configuration management operations of a first auto-configuration server (ACS) and a second ACS, the first ACS corresponding to the apparatus is a master ACS, and the second ACS is a slave ACS; and
communicating with the CPE by using the transmitter.

18. The apparatus of claim 17, wherein the first configuration information is security configuration information.

19. The apparatus of claim 17, wherein the first configuration information is a parameter configured by the first ACS based on a first data model, and the second configuration information is a parameter configured by the second ACS based on a second data model.

20. The apparatus of claim 17, wherein the first data model is a data model based on a non-TR069 protocol.
